(19) United States
(12) Patent Application Publication
(10) Pub. No.: US 2006/0093163 A1
(43) Pub. Date: May 4, 2006

(54) Audio signal manipulator system

(76) Inventor: Lawrence A. Herbert, San Diego, CA (US)

Correspondence Address: WOODS FULLER SHULTZ & SMITH P.C.;ATTN: JEFFREY A. PROEHL, P.O. BOX 5027, SIOUX FALLS, SD, 57117, US

(21) Appl. No.: 10/978,181

(22) Filed: Oct. 29, 2004

(51) Int. Cl. H04B 1/00

(52) U.S. Cl. 381/119

(57) ABSTRACT

An audio signal manipulator system for manually manipulating digital audio signals to simulate the audio sounds emitted when a user mixes vinyl records. The audio signal manipulator system includes a console for storing and manipulating a digital signal input. A multimedia input apparatus for receiving a plurality of digital signal inputs. The multimedia input apparatus is electrically connected to the console. At least one manipulating assembly for manipulating the media currently playing in the console. The manipulating assembly is operationally coupled to the console. At least one sensor mounted on the console for reading a rotational direction and a rotational speed of the manipulating assembly. The sensor selectively operationally engages the manipulating assembly whereby the sensor interprets the rotational direction and the rotational speed of the manipulating assembly to indicate the desired manipulation of the media being played.

### BACKGROUND OF THE INVENTION

1. Field of the Invention

The present invention relates to audio mixers and more particularly pertains to a new audio signal manipulator system for manually manipulating digital audio signals to simulate the audio sounds emitted when a user mixes vinyl records.

2. Description of the Prior Art

The use of audio mixers is known in the prior art. More specifically, audio mixers heretofore devised and utilized are known to consist basically of familiar, expected and obvious structural configurations, notwithstanding the myriad of designs encompassed by the crowded prior art which have been developed for the fulfillment of countless objectives and requirements.

Illustrative of the audio mixers is U.S. Pat. No. 5,675,557 to Hubinger which teaches the use of a manipulator for mixing sound, images and analog supports by user. U.S. Pat. Nos. 5,734,731, 5,647,008, 5,896,459, 5,870,708, 5,184,491, 5,230,024, 5,471,539, 6,434,242, 4,064,364, 4,201,895, 5,126,981, 5,170,381, 5,206,842, 5,293,358, 5,347,499 and 5,444,676 all teach methods and apparatus for mixing multimedia sources together to combine the sources together but requires that a separate unit be used to provide the proper representation of the combination of the sources. U.S. Pat. No. Des. 275,674 shows a disc jockey's combined phonograph, mixer and console.

In these respects, the audio signal manipulator system according to the present invention substantially departs from the conventional concepts and designs of the prior art, and in so doing provides an apparatus primarily developed for the purpose of manually manipulating digital audio signals to simulate the audio sounds emitted when a user mixes vinyl records.

### SUMMARY OF THE INVENTION

In view of the foregoing disadvantages inherent in the known types of audio mixers now present in the prior art, the present invention provides a new audio signal manipulator system construction wherein the same can be utilized for manually manipulating digital audio signals to simulate the audio sounds emitted when a user mixes vinyl records.

To attain this, the present invention generally comprises a console for storing and manipulating a digital signal input. A multimedia input apparatus for receiving a plurality of digital signal inputs. The multimedia input apparatus is electrically connected to the console. At least one manipulating assembly for manipulating the media currently playing in the console. The manipulating assembly is operationally coupled to the console. At least one sensor mounted on the console for reading a rotational direction and a rotational speed of the manipulating assembly. The sensor selectively operationally engages the manipulating assembly whereby the sensor interprets the rotational direction and the rotational speed of the manipulating assembly to indicate the desired manipulation of the media being played.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the use of speaker members coupled to the console to audibly reproduce the sound produced by the user mixing the digital signal inputs.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a front view of a new audio signal manipulator system according to the present invention.

FIG. 2 is a top view of the present invention.

FIG. 3 is a rear view of the present invention.

FIG. 4 is a schematic view of the present invention.

### DESCRIPTION OF PREFERRED EMBODIMENTS

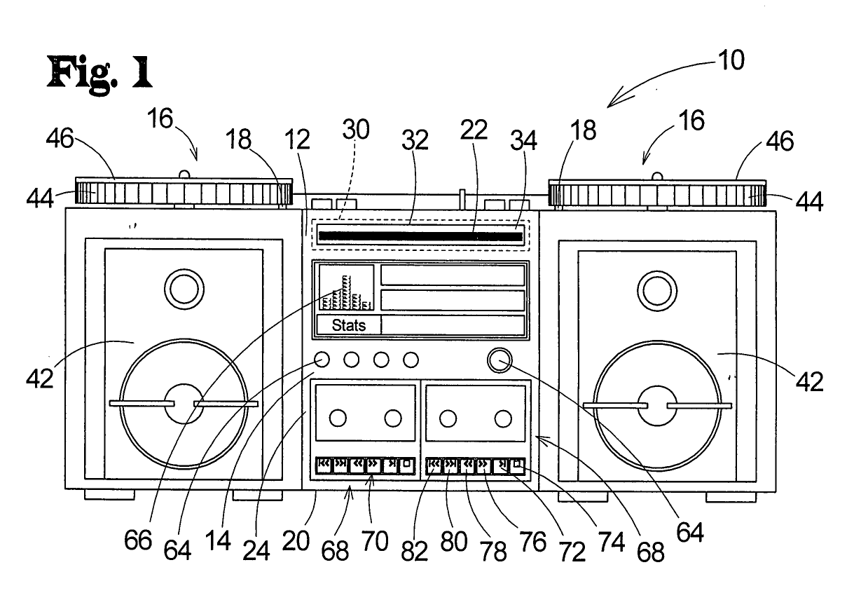

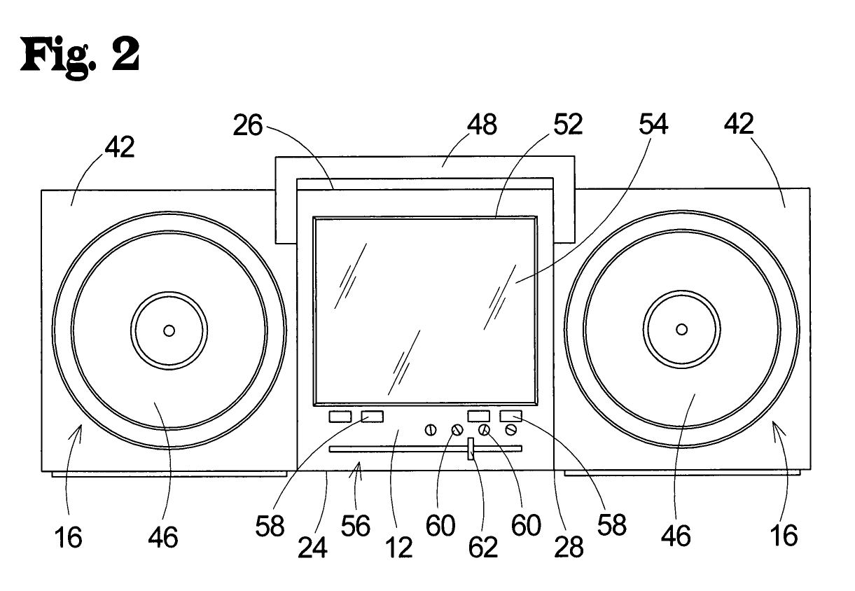

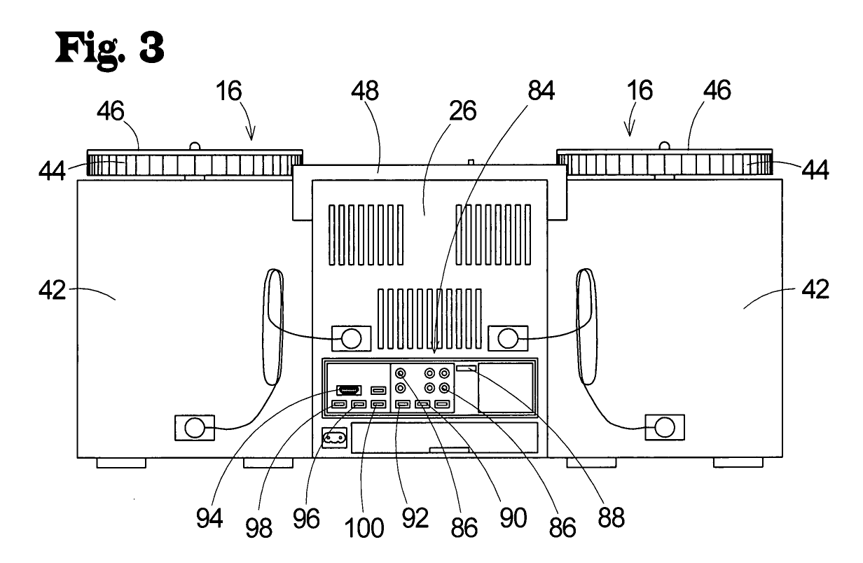

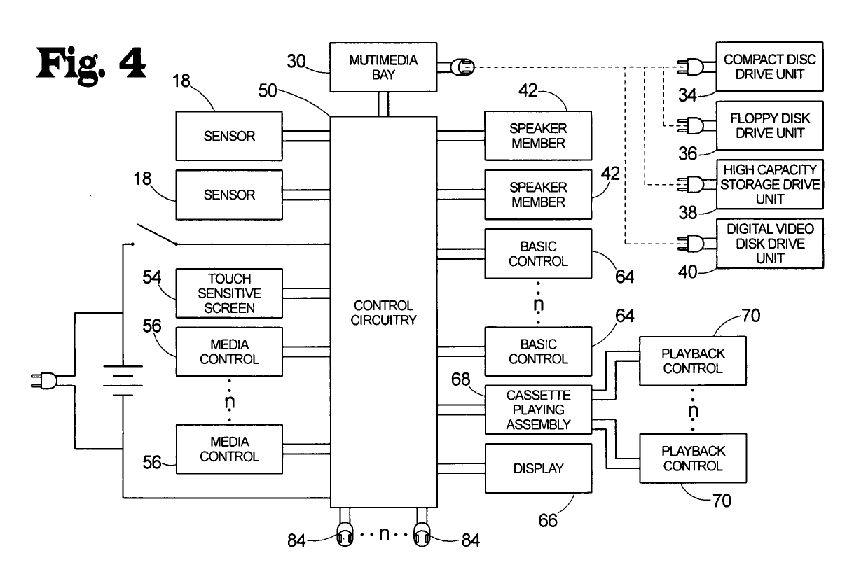

With reference now to the drawings, and in particular to FIGS. 1 through 4 thereof, a new audio signal manipulator system embodying the principles and concepts of the present invention and generally designated by the reference numeral 10 will be described.

As best illustrated in FIGS. 1 through 4, the audio signal manipulator system 10 generally comprises a console 12 for storing and manipulating a digital signal input.

A multimedia input apparatus 14 for receiving a plurality of digital signal inputs. The multimedia input apparatus 14 is electrically connected to the console 12.

At least one manipulating assembly 16 for manipulating the media currently playing in the console 12. The manipulating assembly 16 is operationally coupled to the console 12.

At least one sensor 18 mounted on the console 12 for reading a rotational direction and a rotational speed of the manipulating assembly 16. The sensor 18 selectively operationally engages the manipulating assembly 16 whereby the sensor 18 interprets the rotational direction and the rotational speed of the manipulating assembly 16 to indicate the desired manipulation of the media being played. The console 12 digitally manipulates the media playing in the console 12 to alter an output by the console 12 of the media based on the rotational direction and the rotational speed of the manipulating assembly 16 as interpreted by the at least one sensor 18.

The multimedia input apparatus 14 comprises a housing 20 and at least one multimedia drive 22 removably mounted on the housing 20.

The housing 20 having a front wall 24, a back wall 26 and a peripheral wall 28 extending between the front wall 24 and the back wall 26. The housing 20 comprises at least one multimedia bay 30. The front wall 24 comprises at least one opening 32 extending into the associated multimedia bay 30, wherein the multimedia drive 22 is removably positioned in the multimedia bay 30.

The multimedia drive 22 comprises a plurality of multimedia drives 22 for reading media. One of the multimedia drives 22 comprises a compact disc drive unit 34 being removably positioned in the multimedia bay 30 for reading compact disc media. One of the multimedia drives 22 comprises a floppy disk drive unit 36 being removably positioned in the multimedia bay 30 for reading floppy disk media. One of the multimedia drives 22 comprises a high capacity storage drive unit 38 being removably positioned in the multimedia bay 30 for reading high capacity storage device media. One of the multimedia drives 22 comprises a digital video disk drive unit 40 being removably positioned in the multimedia bay 30 for reading digital video disk media.

A plurality of speaker members 42 are electrically coupled to the multimedia input apparatus 14 whereby the speaker members 42 audibly reproduce output signals from the multimedia input apparatus 14. The speaker members 42 are selectively coupled to the housing 20 of the multimedia input apparatus 14 to be selectively positioned as desired with respect to the housing 20 of the multimedia input apparatus 14. The speaker members 42 are selectively coupled to the housing 20 of the multimedia input apparatus 14 to allow the speaker members 42 and the multimedia input apparatus 14 and console 12 to be transported as a single unit.

The manipulating assembly 16 comprises a platter member 44 and pad member 46. The platter member 44 is rotatably coupled to an associated one of the speaker members 42. The pad member 46 is coupled to the platter member 44 opposite the associated one of the speaker members 42. The pad member 46 is engaged by the user to rotate the platter member 44 with respect to the associated one of the speaker members 42. The sensor 18 senses the speed and direction of rotation of the platter member 44 and alters the sound of digital signals such that they sound similar to the manipulation of vinyl records on a phonograph. The pad member 46 provides a visual representation of a vinyl record normally used for manipulation on a phonograph. The pad member 46 and the platter member 44 have a diameter between about 6 inches and about 9 inches.

A handle 48 is coupled to the housing 20 of the multimedia input apparatus 14 for permitting a user to lift the multimedia input apparatus 14 and speaker members 42 to facilitate transportation to a desired location.

The console 12 comprises control circuitry 50 mounted in the console 12 for controlling the console 12 and for controlling reception of the digital signal inputs from the multimedia input apparatus 14.

The console 12 comprises at least one control panel 52 for controlling storage and playing of the digital signal inputs. The control panel 52 is mounted on the case. The control panel 52 is electrically connected to the control circuitry 50.

The control panel 52 comprises a touch sensitive screen 54. The touch sensitive screen 54 permitting control and manipulation of the digital signal inputs when the touch sensitive screen 54 is actuated by the user. The touch sensitive screen 54 display 66s information relative to the digital signal inputs. The touch sensitive screen 54 is positioned on the console 12 to allow access to the touch sensitive screen 54 by the user.

The console 12 comprises a plurality of media controls 56 for being actuated by the user. The media controls 56 are electrically connected to the control circuitry 50 whereby the media controls 56 are for controlling playback of the digital signal inputs when the media controls 56 are actuated by the user.

The media controls 56 comprise a plurality of mixer controls 58 for permitting the user to mix one of the digital signal inputs with one of the other of the digital signal inputs when the mixer controls 58 are actuated by the user. Each of the mixer controls 58 is electrically connected to the control circuitry 50.

The media controls 56 comprise a plurality of selection controls 60 for permitting the user to selective which one of the digital signal inputs is processed by the control circuitry 50. Each of the selection controls 60 is electrically coupled to the control circuitry 50.

The media controls 56 comprise a fader control 62 for controlling a playback level of one of the digital signal inputs with respect to a playback level of another one of the digital signal inputs when the fader control 62 is actuated by the user. The fader control 62 is electrically coupled to the control circuitry 50.

A plurality of basic controls 64 are electrically coupled to the control circuitry 50. The basic controls 64 are for controlling such features as allowing the user to change the volume produced by the speaker members 42 and to tune the control circuitry 50 to a desired radio station.

A display 66 is coupled to the multimedia apparatus for being viewed by the user. The display 66 display 66s information relative to a selected one of the digital signal inputs that is being played. The display 66 is electrically coupled to the control circuitry 50.

At least one cassette playing assembly 68 is coupled to the multimedia input apparatus 14 for playing back audio from audio cassettes. The cassette playing assembly 68 selectively receives the audio cassette.

The cassette playing assembly 68 comprises a plurality of playback controls 70 for controlling audio playback of the audio cassette when the playback controls 70 are actuated by the user. The playback controls 70 are coupled to the multimedia input apparatus 14 to allow the playback controls 70 to be accessed by the user.

The plurality of playback controls 70 comprise a play button 72 for playing a track of the audio cassette. The play back controls comprise a stop button 74 for stopping the playing of a track of the audio cassette. The play back controls comprise a forward button 76 for advancing a track of the audio cassette. The play back controls comprise a reverse button 78 for reversing a track of the audio cassette. The play back controls comprise a fast forward button 80 76 for quickly advancing a track of the audio cassette. The play back controls comprise a fast reversing button 82 for quickly reversing a track of the audio cassette.

A plurality of jacks 84 are mounted on the multimedia input apparatus 14 for electrically connecting the multimedia input apparatus 14 to a plurality of peripheral devices.

The jacks 84 comprise a plurality of RCA-type jacks 86 84 for electrically connecting the multimedia input apparatus 14 to at least one component to allow digital signals to pass between the component and the multimedia input apparatus 14. The jacks 84 comprise a plurality of Midi-type jacks 88 84 for electrically connecting the multimedia input apparatus 14 to a plurality of MIDI devices. The jacks 84 comprise at least one digital jack 90 for receiving and transmitting digital audio signals to a peripheral device. The jacks 84 comprise at least one small computer system interface jack 92 being connected the multimedia input apparatus 14 for permitting a computer to be coupled to the multimedia input apparatus 14. The small computer interface jack may comprise a serial port 94, a universal serial bus port 96, an ethernet port 98 and a fire wire port 100 or a combination thereof.

In use, the user positions the housing 20 of the multimedia input apparatus 14 and the speaker members 42 at a desired location. The speaker members 42 are then removed from the housing 20 and positioned in a suitable location. The desired media sources are connected to the jacks 84 and the user uses the touch sensitive screen 54 and the media controls 56 to control the source of media used and the levels of the selected media. The manipulating assembly 16 is then used to manipulate the digital signals of the media to imitate the manipulation of vinyl records on a phonograph.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An audio signal manipulator system for manipulating stored audio signals from an audio input device generally corresponding to manipulating a vinyl record on a conventional phonograph, said system comprising:
a console for storing and manipulating a digital signal input;
a multimedia input apparatus for receiving a plurality of digital signal inputs, said multimedia input apparatus being electrically connected to said console;
at least one manipulating assembly for manipulating said media currently playing in said console, said manipulating assembly is operationally coupled to said console;
at least one sensor mounted on said console for reading a rotational direction and a rotational speed of said manipulating assembly, said sensor selectively operationally engaging said manipulating assembly such that said sensor interprets said rotational direction and said rotational speed of said manipulating assembly; and
wherein said console digitally manipulates said media playing in said console to alter an output by said console of said media based on said rotational direction and said rotational speed of said manipulating assembly as interpreted by said at least one sensor.

2. The audio signal manipulator system of claim 1, wherein said multimedia input apparatus comprises a housing and at least one multimedia drive removably mounted on said housing.

3. The audio signal manipulator system of claim 2, wherein said housing has a front wall, a back wall and a peripheral wall extending between said front and back walls, said housing comprising at least one multimedia bay, said front wall comprising at least one opening extending into the associated multimedia bay, wherein said multimedia drive is removably positioned in said multimedia bay.

4. The audio signal manipulator system of claim 1, comprising:
a plurality of speaker members being electrically coupled to said multimedia input apparatus such that said speaker members audibly reproduce output signals from said multimedia input apparatus.

5. The audio signal manipulator system of claim 1, wherein said console comprises control circuitry mounted in said console for controlling said console and for controlling reception of said digital signal inputs from said multimedia input apparatus; and
said console comprising at least one control panel for controlling storage and playing of said digital signal inputs, said control panel being mounted on said case, said control panel being electrically connected to said control circuitry.

6. The audio signal manipulating system of claim 5, wherein said control panel comprises a touch sensitive screen, said touch sensitive screen permitting control and manipulation of said digital signal inputs when said touch sensitive screen is actuated by the user, said touch sensitive screen displaying information relative to said digital signal inputs, said touch sensitive screen being positioned on said console to allow access to said touch sensitive screen by the user.

7. The audio signal manipulator system of claim 5, wherein said console comprises a plurality of media controls for being actuated by the user, said media controls being electrically connected to said control circuitry such that said media controls are for controlling playback of said digital signal inputs when said media controls are actuated by the user.

8. The audio signal manipulator system of claim 7, wherein said media controls comprise a plurality of mixer controls for permitting the user to mix one of said digital signal inputs with one of the other of said digital signal inputs when said mixer controls are actuated by the user, each of said mixer controls being electrically connected to said control circuitry.

9. The audio signal manipulator system of claim 7, wherein said media controls comprise a plurality of selection controls for permitting the user to selective which one of said digital signal inputs is processed by said control circuitry, each of said selection controls being electrically coupled to said control circuitry.

10. The audio signal manipulator system of claim 7, wherein said media controls comprise a fader control for controlling a playback level of one of said digital signal inputs with respect to a playback level of another one of said digital signal inputs when said fader control is actuated by the user, said fader control being electrically coupled to said control circuitry.

11. The audio signal manipulator system of claim 5, further comprising:
a display being coupled to said multimedia apparatus for being viewed by a user, said display displaying information relative to a selected one of said digital signal inputs that is being played, said display being electrically coupled to said control circuitry.

12. The audio signal manipulator system of claim 1, further comprising:
at least one cassette playing assembly being coupled to said multimedia input apparatus for playing back audio from audio cassettes, said cassette playing assembly being for selectively receiving the audio cassette.

13. The audio signal manipulator system of claim 12, wherein said cassette playing assembly comprises a plurality of playback controls for controlling audio playback of the audio cassette when said playback controls are actuated by the user, said playback controls being coupled to said multimedia input apparatus to allow said playback controls to be accessed by the user.

14. The audio signal manipulator system of claim 1, further comprises:
a plurality of jacks being mounted on said multimedia input apparatus for electrically connecting said multimedia input apparatus to a plurality of peripheral devices.

15. The audio signal manipulator system of claim 14, wherein said jacks comprise a plurality of RCA-type jacks for electrically connecting said multimedia input apparatus to at least one component to allow digital signals to pass between the component and said multimedia input apparatus.

16. The audio signal manipulator system of claim 14, wherein said jacks comprise a plurality of MIDI-type jacks for electrically connecting said multimedia input apparatus to a plurality of MIDI devices.

17. The audio signal manipulator system of claim 14, wherein said jacks comprise at least one digital jack for receiving and transmitting digital audio signals to a peripheral device.

18. The audio signal manipulator system of claim 14, wherein said jacks comprise at least one small computer system interface jack being connected to said multimedia input apparatus for permitting a computer to be coupled to said multimedia input apparatus.

19. An audio signal manipulator system for manipulating stored audio signals from an audio input device generally corresponding to manipulating a vinyl record on a conventional phonograph, said system comprising:
a console for storing and manipulating a digital signal input;
a multimedia input apparatus for receiving a plurality of digital signal inputs, said multimedia input apparatus being electrically connected to said console;
at least one manipulating assembly for manipulating said media currently playing in said console, said manipulating assembly is operationally coupled to said console;
at least one sensor mounted on said console for reading a rotational direction and a rotational speed of said manipulating assembly, said sensor selectively operationally engaging said manipulating assembly such that said sensor interprets said rotational direction and said rotational speed of said manipulating assembly;
wherein said console digitally manipulates said media playing in said console to alter an output by said console of said media based on said rotational direction and said rotational speed of said manipulating assembly as interpreted by said at least one sensor;
said multimedia input apparatus comprising a housing and at least one multimedia drive removably mounted on said housing;
said housing having a front wall, a back wall and a peripheral wall extending between said front and back walls, said housing comprising at least one multimedia bay, said front wall comprising at least one opening extending into the associated multimedia bay, wherein said multimedia drive is removably positioned in said multimedia bay;
a plurality of speaker members being electrically coupled to said multimedia input apparatus such that said speaker members audibly reproduce output signals from said multimedia input apparatus;
said console comprising control circuitry mounted in said console for controlling said console and for controlling reception of said digital signal inputs from said multimedia input apparatus;
said console comprising at least one control panel for controlling storage and playing of said digital signal inputs, said control panel being mounted on said case, said control panel being electrically connected to said control circuitry;
said control panel comprising a touch sensitive screen, said touch sensitive screen permitting control and manipulation of said digital signal inputs when said touch sensitive screen is actuated by the user, said touch sensitive screen displaying information relative to said digital signal inputs, said touch sensitive screen being positioned on said console to allow access to said touch sensitive screen by the user;
said console comprising a plurality of media controls for being actuated by the user, said media controls being electrically connected to said control circuitry such that said media controls are for controlling playback of said digital signal inputs when said media controls are actuated by the user;
said media controls comprising a plurality of mixer controls for permitting the user to mix one of said digital signal inputs with one of the other of said digital signal inputs when said mixer controls are actuated by the user, each of said mixer controls being electrically connected to said control circuitry;
said media controls comprising a plurality of selection controls for permitting the user to selective which one of said digital signal inputs is processed by said control circuitry, each of said selection controls being electrically coupled to said control circuitry;
said media controls comprising a fader control for controlling a playback level of one of said digital signal inputs with respect to a playback level of another one of said digital signal inputs when said fader control is actuated by the user, said fader control being electrically coupled to said control circuitry;
a display being coupled to said multimedia apparatus for being viewed by a user, said display displaying information relative to a selected one of said digital signal inputs that is being played, said display being electrically coupled to said control circuitry;
at least one cassette playing assembly being coupled to said multimedia input apparatus for playing back audio from audio cassettes, said cassette playing assembly being for selectively receiving the audio cassette;
said cassette playing assembly comprising a plurality of playback controls for controlling audio playback of the audio cassette when said playback controls are actuated by the user, said playback controls being coupled to said multimedia input apparatus to allow said playback controls to be accessed by the user;
a plurality of jacks being mounted on said multimedia input apparatus for electrically connecting said multimedia input apparatus to a plurality of peripheral devices;
said jacks comprising a plurality of RCA-type jacks for electrically connecting said multimedia input apparatus to at least one component to allow digital signals to pass between the component and said multimedia input apparatus;
said jacks comprising a plurality of MIDI-type jacks for electrically connecting said multimedia input apparatus to a plurality of MIDI devices;
said jacks comprising at least one digital jack for receiving and transmitting digital audio signals to a peripheral device; and
said jacks comprising at least one small computer system interface jack being connected to said multimedia input apparatus for permitting a computer to be coupled to said multimedia input apparatus.
